(19) United States
(12) Patent Application Publication
(10) Pub. No.: US 2025/0048062 A1
(43) Pub. Date: Feb. 6, 2025

(54) MULTICAST AND BROADCAST SERVICE IN VARIOUS RADIO RESOURCE CONTROL STATES

(71) Applicant: ZTE CORPORATION, Shenzhen (CN)

(72) Inventors: Yang LI, Shenzhen (CN); Tao QI, Shenzhen (CN); Lin CHEN, Shenzhen (CN)

(73) Assignee: ZTE CORPORATION, Shenzhen (CN)

(21) Appl. No.: 18/927,133

(22) Filed: Oct. 25, 2024

Related U.S. Application Data
(63) Continuation of application No. PCT/CN2022/096287, filed on May 31, 2022.

(51) Int. Cl. H04W 4/06; H04W 72/30

(52) U.S. Cl. CPC H04W 4/06; H04W 72/30

(57) ABSTRACT

Various arrangements disclosed herein relate to managing Multicast and Broadcast Services (MBSs) in various Radio Resource Control (RRC) states, including a wireless communication device receiving from a network using first signaling specific to the wireless communication device, PTM configuration used for receiving at least one MBS when the wireless communication device is in an RRC-connected state. The wireless communication device receives from the network using second signaling specific to the wireless communication device when the wireless communication device is in the RRC-connected state, indication information indicating that the PTM configuration used for receiving the at least one MBS is obtained from broadcast signaling when the wireless communication device is in an RRC-inactive state.

### CROSS-REFERENCE TO RELATED APPLICATIONS

This application claims the benefit of priority under 35 U.S.C. § 120 as a continuation of PCT Patent Application No. PCT/CN2022/096287, filed on May 31, 2022, the disclosure of which is incorporated herein by reference in its entirety. This application relates to PCT Application No. PCT/CN2022/096285, titled “MULTICAST AND BROADCAST SERVICE IN VARIOUS RADIO RESOURCE CONTROL STATES,” filed on May 31, 2022, and to PCT Application No. PCT/CN2022/096286, titled “MULTICAST AND BROADCAST SERVICE IN VARIOUS RADIO RESOURCE CONTROL STATES,” filed on May 31, 2022, the disclosures of which are incorporated herein by reference in their entirety.

### TECHNICAL FIELD

The present implementations relate generally to wireless communications, and more particularly to systems, methods, apparatuses, and non-transitory computer-readable media for managing Multicast and Broadcast Service (MBS) in various Radio Resource Control (RRC) states.

### BACKGROUND

MBS is one of the most prominent use cases of Fifth Generation Mobile Network (5G) New Radio (NR) and provides reliable, low-latency, and resource-efficient transmission to multiple terminals that receive the same content. MBS's main usage scenarios include deployment in crowded areas with high concentrations of terminals, such as in concerts, sport stadiums, racing tracks, rallies, dense population areas, and so on to send the same content (e.g., a same video). In some examples, MBS content (e.g., a video) is synchronized to the terminal, and multiple viewing angles of the video are needed. In addition, a large number of users and terminals in a same cell watch Virtual Reality (VR) live broadcasts at the same time.

### SUMMARY

In some arrangements, a wireless communication device receives from a network using signaling specific to the wireless communication device, Point-to-Multipoint (PTM) configuration for each of a plurality of MBSs when the wireless communication device is in an RRC-connected state. The wireless communication device transitions from the RRC-connected state to the RRC-inactive state. In response to transitioning to the RRC-inactive state, the wireless communication device receives from the network data for at least one MBS of the plurality of MBSs using the PTM configuration received in the RRC-connected state when the wireless communication device is in an RRC-inactive state.

In some arrangements, a network sends to the wireless communication device using signaling specific to the wireless communication device, PTM configuration for each of a plurality of MBSs when the wireless communication device is in a RRC-connected state. The network releases the wireless communication device to the RRC-inactive state. The network sends to the wireless communication device when the wireless communication device is in the RRC-inactive state, data corresponding to at least one MBS of the plurality of MBSs using PTM configuration sent when the UE is in the RRC-connected state.

In some arrangements, a wireless communication device receives from a network, indication information indicating that PTM configuration for each of a plurality of MBSs is obtained from broadcast signaling when the wireless communication device is in a RRC-connected state. The wireless communication device receives from the network, the PTM configuration from the broadcast signaling used for receiving the plurality of MBSs when the wireless communication device is in the RRC-connected state.

In some arrangements, the network sends to a wireless communication device using signaling specific to the wireless communication device, indication information indicating that PTM configuration for each of a plurality of MBSs is obtained from broadcast signaling used for sending the plurality of MBSs when the wireless communication device is in a RRC-connected state and at least one MBS when the wireless communication device is in an RRC-inactive state. The network sends to the wireless communication device using the broadcast signaling, the PTM configuration used for sending the plurality of MBSs when the wireless communication device is in the RRC-connected state and updated PTM configuration used for sending the at least one MBS when the wireless communication device is in an RRC-inactive state.

In some arrangements, a wireless communication device receives from a network using first signaling specific to the wireless communication device, PTM configuration used for receiving at least one MBS when the wireless communication device is in an RRC-connected state. The wireless communication device receives from the network using second signaling specific to the wireless communication device when the wireless communication device is in the RRC-connected state, indication information indicating that the PTM configuration used for receiving the at least one MBS is obtained from broadcast signaling when the wireless communication device is in an RRC-inactive state.

In some arrangements, a network sends to the to a wireless communication device using first signaling specific to the wireless communication device, PTM configuration used for receiving at least one MBS when the wireless communication device is in an RRC-connected state. The network sends to the wireless communication device using second signaling specific to the wireless communication device when the wireless communication device is in the RRC-connected state, indication information indicating that the PTM configuration used for receiving the at least one MBS is obtained from broadcast signaling when the wireless communication device is in an RRC-inactive state.

The above and other aspects and their implementations are described in greater detail in the drawings, the descriptions, and the claims.

### BRIEF DESCRIPTION OF THE DRAWINGS

These and other aspects and features of the present implementations is apparent to those ordinarily skilled in the art upon review of the following description of specific implementations in conjunction with the accompanying figures, wherein:

FIG. 1 is a diagram illustrating an example wireless communication network, according to various arrangements.

FIG. 2 is a diagram illustrating a block diagram of an example wireless communication system for transmitting and receiving downlink and uplink communication signals, according to various arrangements.

FIG. 3 is a flowchart diagram illustrating an example method for managing MBS, according to various arrangements.

FIG. 4 is a flowchart diagram illustrating an example method for managing MBS, according to various arrangements.

FIG. 5 is a flowchart diagram illustrating an example method for managing MBS, according to various arrangements.

FIG. 6 is a table illustrating example PTM configuration carried in the dedicated RRC reconfiguration specific to the UE, according to various arrangements.

FIG. 7 is a table illustrating an example broadcast PTM configuration carried in the MCCH, according to some arrangements.

FIG. 8 is a flowchart diagram illustrating an example method for managing MBS, according to various arrangements.

FIG. 9 is a flowchart diagram illustrating an example method for managing MBS, according to various arrangements.

FIG. 10 is a flowchart diagram illustrating an example method for managing MBS, according to various arrangements.

FIG. 11 is a flowchart diagram illustrating an example method for managing MBS, according to various arrangements.

FIG. 12 is a flowchart diagram illustrating an example method for managing MBS, according to various arrangements.

FIG. 13 is a flowchart diagram illustrating an example method for managing MBS, according to various arrangements.

### DETAILED DESCRIPTION

The present implementations will now be described in detail with reference to the drawings, which are provided as illustrative examples of the implementations so as to enable those skilled in the art to practice the implementations and alternatives apparent to those skilled in the art. Notably, the figures and examples below are not meant to limit the scope of the present implementations to a single implementation, but other implementations are possible by way of interchange of some or all of the described or illustrated elements. Moreover, where certain elements of the present implementations can be partially or fully implemented using known components, only those portions of such known components that are necessary for an understanding of the present implementations is described, and detailed descriptions of other portions of such known components is omitted so as not to obscure the present implementations. Implementations described as being implemented in software should not be limited thereto, but can include implementations implemented in hardware, or combinations of software and hardware, and vice-versa, as is apparent to those skilled in the art, unless otherwise specified herein. In the present specification, an implementation showing a singular component should not be considered limiting. Rather, the present disclosure is intended to encompass other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present implementations encompass present and future known equivalents to the known components referred to herein by way of illustration.

In MBS deployment scenarios, cell congestion may frequently occurs considering the number of terminals or User Equipments (UEs) connected to the same cell and that the volume of services carried by the cell are limited. The resulted congestion of the cell can lead to rejection and/or reduction the transmission of other services and/or UEs, thus negatively impacting user experience.

In 5G NR, a UE has three Radio Resource Control (RRC) states—an RRC-connected state (RRC_CONNECTED), an RRC-idle state (RRC_IDLE), and an RRC-inactive state (RRC_INACTIVE). The RRC-inactive state is a state defined in 5G NR. For example, when the UE enters the RRC-inactive state, the UE retains a part of the context of the access network. The core network might not be aware of the UE transitioning into the RRC-inactive state. That is, the RRC-inactive state might be transparent to the core network.

In the RRC-inactive state, the UE transitions from the RRC-inactive state to the RRC-connected state through the connection resume process in order to transmit or receive data. The RRC-inactive state not only conserves energy but also manages the delay of the control plane (e.g., the UE can quickly enter the RRC-connected state with lower Control Plane (CP) delay compared to the UE in the RRC-idle state).

In some implementations that involve MBS multicast reception in cell congestion and/or power saving scenarios RRC states can be transitioned to RRC-inactive state for some UEs that applied MBS multicast. Such UEs transition from the RRC-connected state to the RRC-inactive state, to receive or continue receiving the multicast session.

In some implementations, Point-to-Multipoint (PTM) configuration delivery methods are specified. For multicast service or multicast session, dedicated signaling is used. For broadcast service or broadcast session, only broadcast signaling (e.g., System Information Block (SIB) and MBS Control Channel (MCCH)) is used. For broadcast reception in other Secondary Cell (SCell), dedicated signaling that is used to deliver system information can be used. The UEs can receive multicast data or information while in the RRC-inactive state.

The arrangements of the present application relates to enabling a UE to receive or continue receiving multicast services in the RRC-inactive state. In order to receive multicast service, a UE needs to obtain the correct configuration, referred to herein as PTM configuration, multicast configuration, or MBS configurations, which can be used interchangeably. The PTM configuration includes at least information in access layer for a UE to obtain the multicast data. Multicast service and multicast session can be used interchangeably, to identify one multicast service in Radio Access Network (RAN) context.

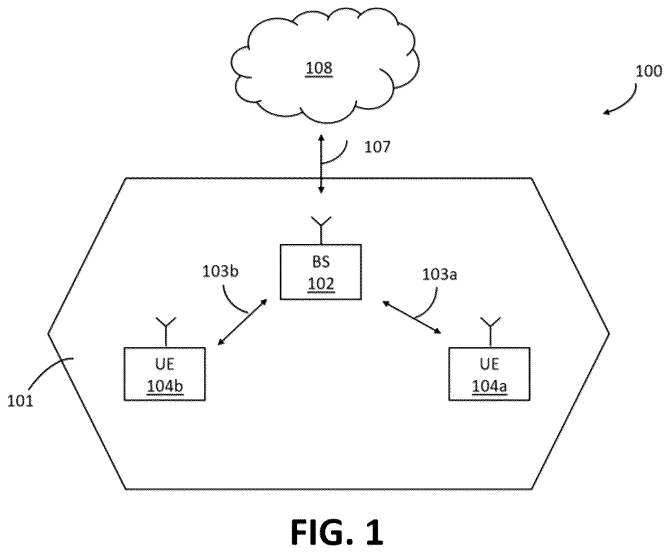

FIG. 1 shows an example wireless communication network 100. The wireless communication network 100 corresponds to a group communication or a multicast service within a cellular network. In the wireless communication network 100, a network-side communication node or a base station (BS) can include one or more of a next Generation Node B (gNB), an E-Utran Node B (also known as Evolved Node B, eNodeB or eNB), a pico station, a femto station, a Transmission/Reception Point (TRP), an Access Point (AP), or the like. A terminal-side node or a UE can include a long range communication system (such as but not limited to, a mobile device, a smart phone, a Personal Digital Assistant (PDA), a tablet, a laptop computer) or a short range communication system (such as but not limited to, a wearable device, a vehicle with a vehicular communication system, or the like). As in FIG. 1, a network-side communication node is represented by a BS 102, and a terminal-side communication node is represented by a UE 104a or 104b. In some arrangements, the BS 102 is sometimes referred to as a “wireless communication node,” and the UE 104a/104b is sometimes referred to as a “wireless communication device.”

As shown in FIG. 1, the BS 102 can provide wireless communication services to the UEs 104a and 104b within a cell 101. The UE 104a can communicate with the BS 102 via a communication channel 103a. Similarly, the UE 104b can communicate with the BS 102 via a communication channel 103b. The communication channels (e.g., 103a and 103b) can be through interfaces such as but not limited to, an Uu interface which is also known as Universal Mobile Telecommunication System (UMTS) air interface. The BS 102 is connected to a Core Network (CN) 108 through an external interface 107, e.g., an NG interface.

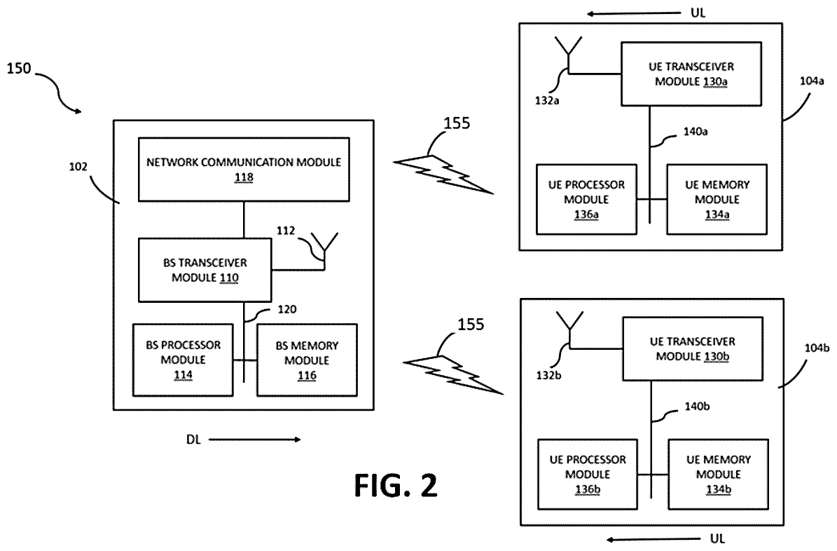

FIG. 2 illustrates a block diagram of an example wireless communication system 150 for transmitting and receiving downlink and uplink communication signals, in accordance with some arrangements of the present disclosure. Referring to FIGS. 1 and 2, the system 150 is a portion of the network 100. In the system 150, data symbols can be transmitted and received in a wireless communication environment such as the wireless communication network 100 of FIG. 1.

The system 150 generally includes the BS 102 and UEs 104a and 104b. The BS 102 includes a BS transceiver module 110, a BS antenna 112, a BS memory module 116, a BS processor module 114, and a network communication module 118. The modules/components are coupled and interconnected with one another as needed via a data communication bus 120. The UE 104a includes a UE transceiver module 130a, a UE antenna 132a, a UE memory module 134a, and a UE processor module 136a. The modules/components are coupled and interconnected with one another as needed via a data communication bus 140a. Similarly, the UE 104b includes a UE transceiver module 130b, a UE antenna 132b, a UE memory module 134b, and a UE processor module 136b. The modules/components are coupled and interconnected with one another as needed via a data communication bus 140b. The BS 102 communicates with the UEs 104a and 104b via communication channels 155, which can be any wireless channel or other medium known in the art suitable for transmission of data as described herein.

The system 150 can further include any number of modules/elements other than the modules/elements shown in FIG. 2. The various illustrative blocks, modules, elements, circuits, and processing logic described in connection with the arrangements disclosed herein can be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionalities. Whether such functionalities are implemented as hardware, firmware, or software depends upon the particular application and design constraints imposed on the overall system. Those familiar with the concepts described herein may implement such functionalities in a suitable manner for each particular application, but such implementation decisions should not be interpreted as limiting the scope of the present disclosure.

A wireless transmission from an antenna of each of the UEs 104a and 104b to an antenna of the BS 102 is known as an uplink transmission, and a wireless transmission from an antenna of the BS 102 to an antenna of each of the UEs 104a and 104b is known as a downlink transmission. In accordance with some arrangements, each of the UE transceiver modules 130a and 130b may be referred to herein as an uplink transceiver, or UE transceiver. The uplink transceiver can include a transmitter circuitry and receiver circuitry that are each coupled to the respective antenna 132a and 132b. A duplex switch may alternatively couple the uplink transmitter or receiver to the uplink antenna in time duplex fashion. Similarly, the BS transceiver module 110 may be herein referred to as a downlink transceiver, or BS transceiver. The downlink transceiver can include RF transmitter circuitry and receiver circuitry that are each coupled to the antenna 112. A downlink duplex switch may alternatively couple the downlink transmitter or receiver to the antenna 112 in time duplex fashion. The operations of the transceivers 110, 130a, and 130b are coordinated in time such that the uplink receiver is coupled to the antenna 132a and 132b for reception of transmissions over the wireless communication channels 155 at the same time that the downlink transmitter is coupled to the antenna 112. In some arrangements, the UEs 104a and 104b can use the UE transceivers 130a and 130b through the respective antennas 132a and 132b to communicate with the BS 102 via the wireless communication channels 155. The wireless communication channel 155 can be any wireless channel or other medium suitable for downlink (DL) and/or uplink (UL) transmission of data as described herein.

The UE transceiver 130a/130b and the BS transceiver 110 are configured to communicate via the wireless data communication channel 155, and cooperate with a suitably configured antenna arrangement that can support a particular wireless communication protocol and modulation scheme. In some arrangements, the UE transceiver 130a/130b and the BS transceiver 110 are configured to support industry standards such as the Long Term Evolution (LTE) and emerging 5G standards, or the like. It is understood, however, that the present disclosure is not necessarily limited in application to a particular standard and associated protocols. Rather, the UE transceiver 130a/130b and the BS transceiver 110 may be configured to support alternate, or additional, wireless data communication protocols, including future standards or variations thereof.

The processor modules 136a and 136b and 114 may be each implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, methods or algorithms described in connection with the arrangements disclosed herein may be embodied directly in hardware, in firmware, in a software module executed by processor modules 114, 136a, and 136b, respectively, or in any practical combination thereof. The memory modules 116, 134a, 134b can be realized as RAM memory, flash memory, ROM memory, EPROM memory, EEPROM memory, registers, a hard disk, a removable disk, a CD-ROM, or another suitable form of storage medium. In this regard, the memory modules 116, 134a, and 134b may be coupled to the processor modules 114, 136a, and 136b, respectively, such that the processors modules 114, 136a, and 136b can read information from, and write information to, the memory modules 116, 134a, and 134b, respectively. The memory modules 116, 134a, and 134b may also be integrated into their respective processor modules 114, 136a, and 136b. In some arrangements, the memory modules 116, 134a, and 134b may each include a cache memory for storing temporary variables or other intermediate information during execution of instructions to be executed by processor modules 114, 136a, and 136b, respectively. Memory modules 116, 134a, and 134b may also each include non-volatile memory for storing instructions to be executed by the processor modules 114, 136a, and 136b, respectively.

The network interface 118 generally represents the hardware, software, firmware, processing logic, and/or other components of the BS 102 that enable bi-directional communication between BS transceiver 110 and other network components and communication nodes configured to communication with the BS 102. For example, the network interface 118 may be configured to support internet or WiMAX traffic. In a typical deployment, without limitation, the network interface 118 provides an 802.3 Ethernet interface such that BS transceiver 110 can communicate with a conventional Ethernet based computer network. In this manner, the network interface 118 may include a physical interface for connection to the computer network (e.g., Mobile Switching Center (MSC)). The terms “configured for” or “configured to” as used herein with respect to a specified operation or function refers to a device, component, circuit, structure, machine, signal, etc. that is physically constructed, programmed, formatted and/or arranged to perform the specified operation or function. The network interface 118 can allow the BS 102 to communicate with other BSs or core network over a wired or wireless connection.

The BS 102 can communicate with a plurality of UEs (including the UEs 104a and 104b) using multicast or broadcast, collectively referred to as MBS. The plurality of UEs can each receive MBS service via multicast and/or broadcast. In order to receive the MBS service, the plurality of UEs have a common understanding on the configurations of the MBS service, including but not limited to, frequency resource range for resource allocation, scrambling sequence, and so on, referred to herein as PTM configuration, multicast configuration, or MBS configurations. The network (e.g., the BS 102 or the cell 101) can deliver the PTM configuration for MBS multicast reception for the UE 104a or 104b in different RRC states.

In some arrangements, the UE 104a or 104b receives the PTM configuration or updates thereof from the network (e.g., the BS 102 or the cell 101) through dedicated signaling specific to the UE. An example of the dedicated signaling includes RRC reconfiguration signaling. For example, when the UE in the RRC-inactive state, the UE initiates the RRC connection resume process to receive the PTM configuration update. When the UE is in the RRC-connected state, the PTM configuration is delivered by the network via dedicated signaling.

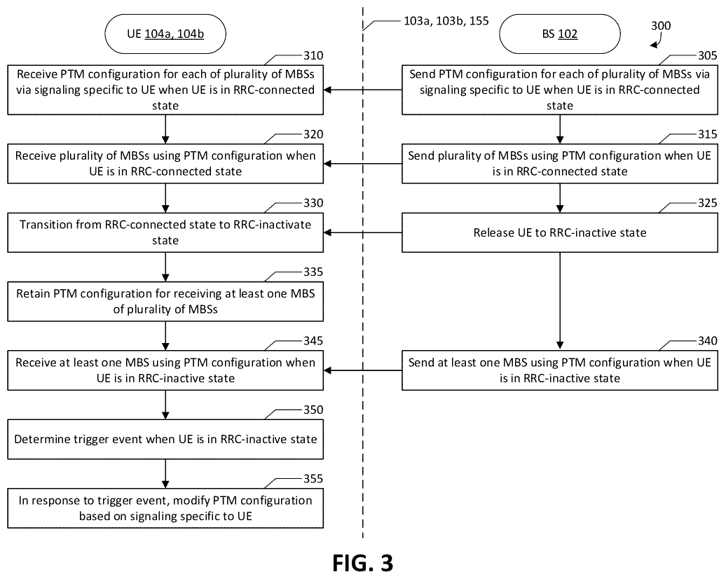

FIG. 3 is a flowchart diagram illustrating a method 300 for managing MBS, according to various arrangements. Referring to FIGS. 1-3, the method 300 can be performed by the network (e.g., the BS 102) and one of UE 104a or 104b. Communications between the UE and the BS are performed over respectively ones of the channels 103a, 103b, or 155, shown as the dashed line in FIG. 3.

At 305, the network (e.g., the BS 102) sends PTM configuration for each of a plurality of MBSs to the UE using signaling specific to the UE (e.g., dedicated signaling) when the UE is in the RRC-connected state. At 310, the UE receives the PTM configuration for each of the plurality of MBSs using signaling specific to the UE when the UE is in the RRC-connected state. Accordingly, for a UE that is in the RRC-connected state, the PTM configuration is delivered to UE by dedicated signaling.

At 315, the network sends data corresponding to the plurality of MBSs using the PTM configuration received at 310 when the UE is in the RRC-connected state. At 320, the UE receives from the network the data corresponding to the plurality of MBSs using the PTM configuration when the UE is in the RRC-connected state.

At 325, the network releases the UE to the RRC-inactive state. For example, the network sends signaling or message that indicates to the UE that the UE is to be released to the RRC-inactive state. At 330, the UE transitions from the RRC-connected state to the RRC-inactive state.

To continue the multicast reception on some MBS (referred to as at least one MBS) that the UE has been receiving since the RRC-connected state (e.g., at 320), the corresponding PTM configuration, which includes the MRB and the lower layer configuration of the multicast session associated with the at least one MBS, is retained. For example, at 335, the UE retains the PTM configuration for the at least one MBS. The at least one MBS may be some but not all of the plurality of MBSs in some examples. In other examples, the at least one MBS may be all of the plurality of MBSs.

At 340, the network sends the at least one MBS using the retained PTM configuration when the UE is in the RRC-inactive state. At 345, the UE receives the at least one MBS using the retained PTM configuration when the UE is in the RRC-inactive state.

At 350, the UE may determine a trigger event when the UE is in the RRC-inactive state. In some examples, the network may initiate paging to notify the UE of the trigger event such as modifying to the retained PTM configuration (including multicast session deactivation, activation, suspension, release, resumption, update, and so on). In some examples, in the trigger event includes the UE detecting that the multicast reception quality degrades past a certain threshold, such that UE initiates RRC connection to resume process to update the retained PTM configuration through dedicated signaling. In response to the trigger event, the UE modifies the retained PTM configuration based on the signaling specific to the UE (dedicated signaling). Examples of the signaling specific to the UE includes RRC reconfiguration message or RRC release message that is sent to the UE alone and having content specific to the UE.

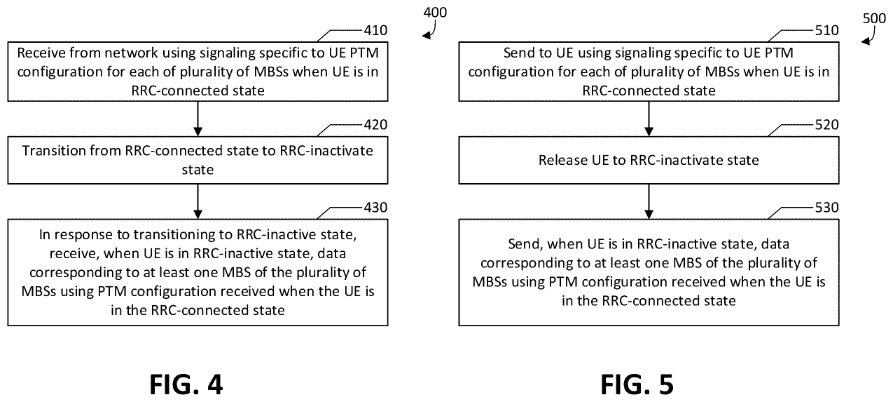

FIG. 4 is a flowchart diagram illustrating an example method 400 for managing MBS, according to various arrangements. Referring to FIGS. 1-4, the method 400 can be performed by one of UE 104a or 104b. The method 300 is a particular implementation of the method 400.

At 410, the UE receives the PTM configuration for each of the plurality of MBSs using signaling specific to the UE when the UE is in the RRC-connected state. Accordingly, for a UE that is in the RRC-connected state, the PTM configuration is delivered to UE by dedicated signaling.

At 420, the UE transitions from the RRC-connected state to RRC-inactive state. At 430, in response to transitioning to the RRC-inactive state, receive, when the UE is in an RRC-inactive state, data for at least one MBS of the plurality of MBSs using the PTM configuration received in the RRC-connected state.

In some arrangements, the method 400 further includes determining, by the UE when in the RRC-inactive state, a trigger event. In response to determining the trigger event, modifying, by the UE, the PTM configuration to the UE.

FIG. 5 is a flowchart diagram illustrating an example method 500 for managing MBS, according to various arrangements. Referring to FIGS. 1-5, the method 500 can be performed by the network (e.g., the BS 102). The method 300 is a particular implementation of the method 500.

At 510, the network sends to the UE the PTM configuration for each of the plurality of MBSs using signaling specific to the UE when the UE is in the RRC-connected state. Accordingly, for a UE that is in the RRC-connected state, the PTM configuration is delivered to UE by dedicated signaling.

At 520, the network releases the UE from the RRC-connected state to the RRC-inactive state. At 530, the network sends, when the UE is in an RRC-inactive state, data for at least one MBS of the plurality of MBSs using the PTM configuration sent when the UE is in the RRC-connected state.

In some arrangements, the method 500 further includes sending, by the network to the UE using signaling specific to the UE or broadcast signaling when the UE is in the RRC-inactive state, updated PTM configuration for the at least one MBS.

In some arrangements, with respect to continue to receive, when the UE is in the RRC-inactive state, the at least one MBS which is a subset of the plurality of MBSs received when the UE is in the RRC-connected state, the at least one MBS to be received or continue to be received in the RRC-inactive state is identified. That is, not all of the plurality of MBSs need to be or are able to be received when the UE is in RRC-inactive state. The at least one MBS is a subset of the plurality of MBSs received when the UE is in the RRC-connected state using the PTM configuration.

For example, when the UE in the RRC-inactive state, the network (e.g., the BS 102) is not able to adjust the configuration according to the UE's reception quality adaptively compared to UE in RRC-connected. Therefore, an MBS with high Quality of Service (QOS) requirements is not be transmitted to the UE when the UE is in the RRC-inactive state. The selection of the at least one MBS can be determined by the UE or by the BS 102.

In some examples, UE determines whether the MBS can be received in the RRC-inactive state based on one or more conditions. In that regard, the method 400 further includes selecting, by the UE, the at least one MBS from the plurality of MBSs based on QoS requirements of each of the plurality of MBSs.

The factors can include whether the PTM configuration of the MBS includes a mechanism for high QoS requirement. In the examples in which the PTM configuration of an MBS includes a mechanism for high QoS, the MBS is suspended in the RRC-inactive state. On the other hand, in the examples in which the PTM configuration of an MBS does not include any mechanism for high QoS, the MBS continues to be received in the RRC-inactive state. The factors for determining high QoS requirements include at least one of whether Hybrid Automatic Repeat Request (HARQ) feedback is configured for each of the plurality of MBSs, whether Acknowledge Mode (AM) of Radio Link Control (RLC) is configured for at least one MBS Radio Bearer (MRB) for each of the plurality of MBSs; or whether Packet Data Convergence Protocol (PDCP) status report is configured for the at least one MRB for each of the plurality of MBSs. In other words, the UE considers whether the PTM configuration includes a mechanism for high QoS requirement by considering whether there is HARQ feedback configured, whether there is RLC AM mode for the configured MRB, whether there is PDCP status report reporting configured for some MRB, or so on. In some examples, HARQ feedback being configured for an MBS indicates that the MBS has high QoS requirement. In some examples, AM of RLC being enabled for an MBS indicates that the MBS has high QoS requirement. In some examples, PDCP status report being enabled for an MBS indicates that the MBS has high QoS requirement.

In some examples, in response to determining that each of the at least one PTM configuration meets the condition to be retained (e.g., lack of high QoS mechanism), the PTM configuration of the corresponding MBS session (e.g., the at least one MBS) is retained (not suspended) in response to 330, and data for the at least one MBS can be received in the RRC-inactive state. In some examples, in response to determining that an MRB of each of the at least one PTM configuration meets the condition to be retained (e.g., lack of high QoS mechanism), the corresponding lower layer configuration of the corresponding MBS session (e.g., the at least one MBS) is retained (not suspended) in response to 330, and the at least one MBS can be received in the RRC-inactive state for the corresponding MBS multicast session.

In some examples, the network (e.g., the BS 102) determines whether the MBS can be received in the RRC-inactive state based on one or more conditions. For example, the network may determine to stop transmitting, when the UE is in the RRC-inactive state, an MBS or a session thereof with low QoS requirements that, for example, has no data transmission, intermittent data transmission, or temporary data transmission. To reduce the energy consumption of the UE monitoring for MBS with low QoS requirements, the network can indicate to the UE whether a MBS is transmitted to UE when the UE is RRC-inactive. In other words, an indication from the network to the UE can selectively indicate which MBS or MRB is needed for the UE when the UE is in the RRC-inactive state for the UE to receive the MBS data or continue receiving the multicast data. Thus, the method 400 further includes receiving, by the UE from the base station, an indication that identifies the at least one MBS, wherein the at least one MBS is received or continued to be received in RRC-inactive in response to receiving the indication. The method 500 further includes determining, by the network, to send or continue to send the at least one MBS to the UE when the UE is in the RRC-inactive and sending, by the network to the UE, an indication that identifies the at least one MBS.

The network can send such indication via RRC signaling in some arrangements. In some examples, the RRC signaling includes RRC reconfiguration. The RRC reconfiguration signaling or message includes the indication information that the retained PTM configuration for the at least one MBS is retained when the UE is in the RRC-inactive state. In other words, after the UE receives the RRC release with suspend configuration and transitions to the RRC-inactive state at 330, the UE retains the retained PTM configuration which includes all the multicast MRB or some MRB indicated in the RRC reconfiguration and the corresponding lower layer configuration of the corresponding MBS session. The UE receives or continues receiving the data for the corresponding at least one MBS in RRC-inactive state.

In some examples, the indication that identifies the retained PTM configuration can be per MBS or per MRB. In other words, the indication can identify each of the at least one MBS (the indication information may include the list of MBS identities, e.g., Temporary Mobile Group Identity (TMGI)) to be retained or identify each MRB to be used for the at least one MBS. If such indication is per MRB, the UE retains only the indicated MRB and the lower layer configuration of the at least one MBS identified when in the RRC-inactive state. That is, the other MRBs of the PTM configuration are suspended upon transitioning into the RRC-inactive state. If such indication is per MBS, all the MRB and the lower layer configuration of the at least one MBS identified by the indication is retained upon transitioning into the RRC-inactive state. No MRB associated with the at least one MBS identified in the indication is suspended upon transitioning into the RRC-inactive state.

In some examples, the RRC signaling includes an RRC release, which includes a list of indication information about which PTM configuration (referred to as the at least one MBS) is retained when the UE is in the RRC-inactive state. The indication information may include the list of MBS identities, e.g., Temporary Mobile Group Identity (TMGI). In response to the UE receiving the RRC release with suspend configuration from the network (e.g., at 325), the UE does not suspend any MRB associated with the at least one MBS in the list and will not reset the HARQ process and relevant timers associated with the at least one MBS. The UE receives or continues receiving the data for the at least one MBS in the RRC-inactive state. In some examples, the network provides a list of MRB ID(s) together with the multicast service list in the RRC release signaling or message. The UE retains only the indicated MRB and suspends other MRBs.

Therefore, the indication is received by the UE via RRC reconfiguration or RRC release. The indication comprises an indication for each of the plurality of MBSs or for each MRB associated with the plurality of MBSs. The indication includes a list of the at least one MBS or at least one MRB to be retained when the UE is in the RRC-inactive state. In some examples, in response to transitioning to the RRC-inactive state, the UE performs at least one of: retaining (e.g., not suspending) the indicated at least one MRB, stopping all running timers except multicast Discontinuous Reception (DRX) timer for the indicated at least one MBS, flushing soft buffers for all downlink HARQ processes except for downlink HARQ process being used for the indicated at least one MBS, or continuing to monitor Group-Radio Network Temporary Identifier (G-RNTI) corresponding to the indicated at least one MBS.

In some arrangements, the trigger event includes the network (e.g., the BS 102) sending a notification to the UE. The UE, in response to receiving the notification, modifies the PTM configuration for at least one MBS. In some examples, the notification includes paging. The network can apply a group paging mechanism for notifying multiple UEs through paging. The paging payload of the paging contains an MBS sessions ID list, e.g., a list of TMGIs, that the UE has joined. The notification further includes the notification event associated with the MBS session ID.

For UEs receiving MBS in the RRC-inactive state, the trigger event or conditions for group paging include MBS suspension, MBS resumption, MBS deactivation, MBS activation, MBS release, or PTM configuration update to reduce unnecessary monitoring energy consumption and reduce the frequency of RRC state transitions.

With respect to MBS suspension, the notification indicates that one MBS of the at least one MBS is to be suspended. Modifying the PTM configuration includes stop monitoring, by the UE, the one MBS when the UE is in the RRC-inactive state and suspending the PTM configuration corresponding to the one MBS when the UE is in the RRC-inactive state. For example, the Radio Access Network (RAN) node suspends the transmission of an MBS. Therefore, the UE does not need to resume RRC connection to receive the suspension configuration but can instead stay in RRC-inactive state to suspend the MBS reception configuration by, for example, suspending the associated MRB and stopping the MBS data reception in MAC and physical layer (e.g., stopping G-RNTI of the MBS monitoring).

When the UE is in the RRC-inactive state, if there is temporarily no data being transmitted in RAN, the monitoring of MBS data will cause unnecessary power consumption. To improve power efficiency, the group paging function (e.g., the notification) can be used by the network to notify the UE that certain MBS is suspended or to indicate to the UE to stop monitoring of such MBS and suspend the associated PTM configuration (i.e., without releasing the configuration). In one example, an indication information, e.g., 1 bit indication, is associated with the MBS session identity in the group paging payload, which indicates that the MBS session has been suspended. Upon receiving of such group paging, the UE stops monitoring the MBS data and suspends the associated PTM configuration. In one example, if there is no such indication information, the UE initiates the traditional RRC connection resume process, transitions to the RRC-connected state.

With respect to MBS resumption, the network resumes the transmission of MBS. Therefore, the UE resumes the associated MRB and resumes the G-RNTI monitoring of the resumed MBS, while staying in RRC-inactive state. Therefore, the notification indicates that one MBS is to be resumed. Modifying the PTM configuration includes resuming, by the UE, PTM configuration corresponding to the one MBS when the UE is in the RRC-inactive state and receiving, by the UE, the one MBS using the PTM configuration when the UE is in the RRC-inactive state.

To improve power efficiency, certain MBS with low QoS with no data temporally for UE can be suspended when the UE is in the RRC-inactive state. The network can use the group paging function (e.g., the notification) to resume the reception of such MBS. In one example, an indication information, e.g., 1 bit indication, is associated with the MBS session identity in the group paging payload, which indicates that the MBS session has been resumed. Upon receiving of such group paging, the UE resumes the corresponding MBS MRB(s) and the lower layer configuration of the MBS session and starts the multicast data monitoring. In one example, if there is no such indication information, the UE initiates the traditional RRC connection resume process, transitions to the RRC-connected state.

With respect to MBS deactivation, in response to receiving the MBS deactivation signaling from core network, the RAN node releases the MBS radio resources and stops the MBS transmission. In response to receiving the notification indicating deactivating an MBS, the UE releases the associated PTM configuration (e.g., MRB and PTM configuration in lower layer), and stops the multicast reception. Therefore, the notification indicates that one MBS of the at least one MBS is to be deactivated. Modifying the PTM configuration includes stop monitoring, by the UE, the one MBS when the UE is in the RRC-inactive state and releasing the PTM configuration corresponding to the one MBS when the UE is in the RRC-inactive state.

If there is no data for a MBS being transmitted, and the MBS is deactivated in the network, the monitoring of MBS data for UE in RRC-inactive state causes unnecessary power consumption. Although the network can also notify the UE to resume RRC connection, which may results in more signaling overhead. To improve power efficiency, the network uses group paging function (e.g., the notification) to notify the UE that certain MBS is deactivated. Upon receiving the indication, the UE stops the monitoring of such MBS and releases the associated PTM configuration.

In one example, an indication information, e.g., 1 bit indication, is associated with the MBS session identity in the group paging payload, which indicates that the MBS session has been deactivated. Upon receiving of such group paging, the UE stops monitoring the MBS data monitoring and releases the associated PTM configuration. In one example, if there is no such indication information, the UE initiates the traditional RRC connection resume process, transitions to the RRC-connected state.

With respect to PTM configuration update. The network can update the PTM configuration of certain ones of the at least one MBS. If the network updates the PTM configuration, e.g., network reassigns the radio resources for an MBS, the UE may need to transition states between RRC-inactive and RRC-connected state frequently which causes unnecessary power consumption and signaling overhead. To improve power and air interface resource efficiency, the network uses the group paging function (e.g., the notification) to notify the UE that the PTM configuration of certain multicast is updated and/or to indicate the delivery method of updated configuration (i.e., RRC dedicated signaling or MCCH).

In one example, an indication information, e.g., 1 bit indication, is associated with the MBS session identity in the group paging payload, which indicates that the PTM configuration of the MBS session has been updated. Upon reception of such group paging, UE initiates the RRC connection resume process and may add a resume cause value to indicate that the reason of resume is to update of the PTM configuration. The BS 102 can add PTM configuration in the RRC message, e.g., RRC release. Upon receiving the RRC message, the UE updates the PTM configuration of the associated MBS and continues to receive data for that MBS in the RRC-inactive state. In some examples, the notification indicates that PTM configuration for one MBS of the at least one MBS is to be updated. Modifying the PTM configuration includes initiating, by the UE, the RRC connection resume process, in response to initiating the RRC connection resume process, the UE receives from the network, the indication information for the one MBS of the at least one MBS. In some examples, the UE receives the updated PTM configuration for the one MBS of the at least one MBS, and the UE receives from the network the data corresponding to the based on the updated PTM configuration. In some examples, the indication information is the updated PTM configuration and is received by the UE via RRC release. Accordingly, while the UE initiates the RRC connection resume process, the updated PTM configuration is sent to the UE via RRC release in some examples. In other examples, the UE initiates the RRC connection resume process and actually enters the RRC-connected state to receive the updates. In one example, the indication information is the updated PTM configuration, UE in the RRC resume message indicates the MBS session ID, or use the MBS session ID as the UE Contention Resolution Identity in the random access procedure. In the following RRC release message, it includes the updated PTM configuration.

In another example, an indication information, e.g., 1 bit indication, is associated with the MBS session identity in the group paging payload, which indicates that the PTM configuration of the MBS session has been updated. Upon receiving of such group paging, the UE updates the PTM configuration which obtained from broadcast singling (e.g., MCCH), and continues to receive the data for that MBS in the RRC-inactive state. In some examples, the network sends the indication information to the UE via RRC release, to indicate to the UE to obtain the updated PTM configuration from broadcast signaling (e.g., MCCH). The updated PTM configuration is received by the UE from broadcast signaling (e.g., MCCH).

In another example, if there is no such indication information, the UE initiates the traditional RRC connection resume process, transitions to the RRC-connected state.

The network can send the notification that indicates modification to the PTM configuration of the at least one MBS using signaling such as group paging associated with the MBS session ID list in the paging payload. Depending on the supported functionality, the notification may have different lengths. For example, if only suspension and resumption need to be indicated, one bit is needed. If all suspension, resumption, deactivation, and update functions need to be supported, 2 bits are needed.

In some arrangements, when the UE in the RRC-inactive state, the update of PTM configuration can be triggered by the MAC CE. When the UE is in the RRC-inactive state, the network can use MAC CE to indicate the update of the PTM configuration (including suspension, resumption, deactivation, and update for certain MBS).

In one example, the MAC CE which includes indication information identified by a corresponding Logic Channel ID (LCID) is transmitted by the network to the UE (e.g., via multiplexed with multicast data) to indicate one or more of suspension, resumption, deactivation, and update for a certain MBS.

With respect to MBS suspension, the RAN node (e.g., the BS 102) suspends the transmission of MBS. Therefore, UE does not need to resume RRC connection to receive the suspension configuration and instead stays in the RRC-inactive state to suspend the MBS reception configuration, e.g., by suspending the associated MRB and stopping the MBS data reception in MAC and physical layer. For example, the UE can stop G-RNTI of the multicast service monitoring.

With respect to MBS resumption, the network resumes the transmission of the MBS. Therefore, the UE resumes the associated MRB, and resumes the G-RNTI monitoring, while staying in the RRC-inactive state.

With respect to MBS deactivation, in response to receiving of the MBS deactivation signaling from core network, the RAN node (e.g., the BS 102) releases the MBS radio resources and stops the MBS transmission. In response to receiving such indication, the UE releases the associated PTM configuration (e.g., MRB and PTM configuration in lower layer), and stops the MBS reception.

With respect to PTM configuration update, the network can update the PTM configuration of certain MBSs. In response to receiving an MAC CE that indicates update, the UE initiates the RRC connection resume process and add a resume cause value to indicate that the reason for resuming RRC is to update of the PTM configuration of the MBS.

In some examples, the network can transmit the MAC CE to the UE by PTM, identified by the corresponding G-RNTI associated with the MBS.

Thus, in some arrangements, determining the trigger event includes receiving, by the UE from the network when the UE is in the RRC-inactive state, a MAC CE indicating that the PTM configuration for one MBS of the at least one MBS is to be modified. The MAC CE includes a service ID or a service index of the one MBS. Modifying the PTM configuration comprises one of MBS suspension, MBS resumption, MBS deactivation, or updating the PTM configuration.

In some arrangements, when the UE is in the RRC-inactive state, the RRC connection resume process is triggered when the MBS reception quality downgrades to a certain threshold. The MBS reception quality can be determined by the BS 102 or the UE. For example, the UE can measure at least one of Reference Signal Received Power (RSRP) or Reference Signal Received Quality (RSRQ) of the configured measurement resources, packet loss rate (e.g., in Packet Data Convergence Protocol (PDCP), or Block Error Rate (BLER) in Layer 1), and so on. The network (e.g., the BS 102) can indicate relevant thresholds in the dedicated signaling to the UE, or alternatively, the UE can determine the relevant thresholds. Accordingly, in other words, the reception quality is determined based on at least one of measured signal strength or packet loss rate.

When the UE is in the RRC-inactive state, the UE continuously monitors these indicators (e.g., measured signal strength or packet loss rate) while receiving the at least one MBS. The UE initiates the RRC connection resume process in response to determining that the reception quality of an MBS downgrades the threshold. The UE sets the resume cause value to indicate that the reason to initiate the RRC connection resume process is reception quality degradation.

In some examples, the network (e.g., the BS 102) can resume the RRC connection of the UE to update the PTM configuration or add PTM configuration in the dedicated signaling, e.g., RRC release. Upon receiving of such RRC message, the UE updates the PTM configuration of the MBS and continues to receive data for that MBS in RRC-connected or RRC-inactive state.

Accordingly, in some examples, determining the trigger event includes determining, by the UE when the UE is in the RRC-inactive state, that a reception quality of one MBS of the at least one MBS is below a threshold. Modifying the PTM configuration includes initiating, by the UE, the RRC connection resume process and adding a resume cause value to indicate that the RRC connection resume process is initiated to update the PTM configuration for the one MBS. Further, the UE receives from the network, updated PTM configuration for the one MBS. The UE receives from the network one MBS using the updated PTM configuration.

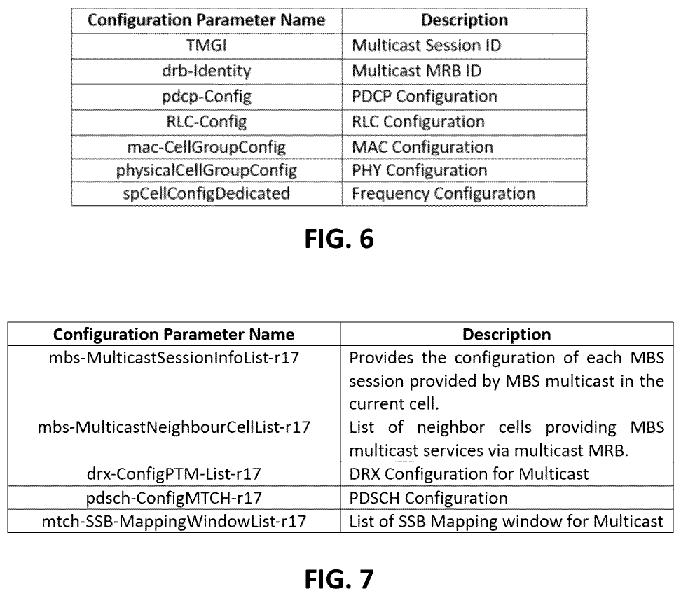

In some arrangements, when the UE in the RRC-inactive state, to reduce the frequency of state transitions caused by the PTM configuration update, the PTM configuration can be delivered in the RRC release. Therefore, modifying the PTM configuration for the at least one MBS includes receiving updated PTM configuration in RRC release signaling, wherein the updated PTM configuration includes at least one of multicast configuration and broadcast configuration. The forms of PTM configuration in RRC release include but are not limited to the multicast configuration carried in the dedicated RRC reconfiguration specific to the UE or the broadcast PTM configuration carried in the MCCH for multiple UEs. For example, FIG. 6 is a table illustrating example PTM configuration carried in the dedicated RRC reconfiguration specific to the UE according to some arrangements. FIG. 7 is a table illustrating an example broadcast PTM configuration carried in the MCCH according to some arrangements.

In some arrangements, when the UE 104a or 104b in RRC-connected or RRC-inactive state, the UE receives the PTM configuration or updates thereof from the network (e.g., the BS 102 or the cell 101) via broadcast signaling (e.g., MCCH). For example, when the UE in the RRC-connected state, the UE monitors broadcast signaling or MCCH to receive PTM configuration or updates thereof for multicast. When the UE is in the RRC-inactive state, the UE monitors the broadcast signaling or MCCH to receive PTM configuration or updates thereof for multicast, such that there is no need for the UE to resume RRC connection to receive the PTM configuration or updates thereof.

In some arrangements, to minimize protocol modification, the multicast PTM configuration carried in the MCCH can be the same as the broadcast PTM configuration, an example of which is shown in FIG. 7.

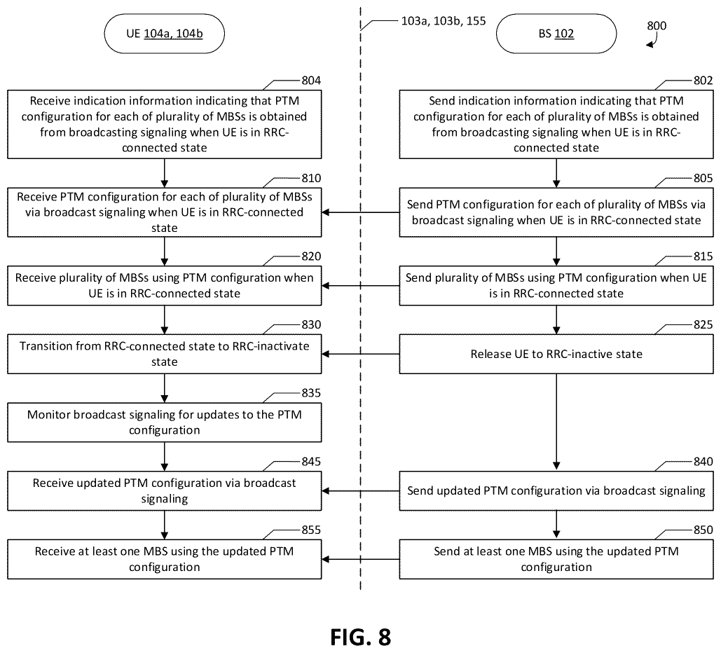

FIG. 8 is a flowchart diagram illustrating an example method 800 for managing MBS, according to various arrangements. Referring to FIGS. 1-8, the method 800 can be performed by the network (e.g., the BS 102) and one of UE 104a or 104b. Communications between the UE and the BS are performed over respectively ones of the channels 103a, 103b, or 155, shown as the dashed line in FIG. 8.

At 802, the network (e.g., the BS 102) sends indication information indicating that PTM configuration for each of a plurality of MBSs is obtained from broadcast signaling when the UE is in the RRC-connected state. At 804, the UE receives the indication information indicating that PTM configuration for each of the plurality of MBSs is obtained from broadcast signaling, where the broadcast signaling is received when the UE is in the RRC-connected state.

At 805, the network (e.g., the BS 102) sends PTM configuration for each of the plurality of MBSs to the UE using broadcast signaling to the UE when the UE is in the RRC-connected state. At 810, the UE receives the PTM configuration for each of the plurality of MBSs using broadcast signaling when the UE is in the RRC-connected state. Accordingly, for a UE that is in the RRC-connected state, the PTM configuration is delivered to UE by broadcast signaling.

At 815, the network sends data corresponding to the plurality of MBSs using the PTM configuration received at 810 when the UE is in the RRC-connected state. At 820, the UE receives from the network the data corresponding to the plurality of MBSs using the PTM configuration when the UE is in the RRC-connected state.

At 825, the network releases the UE to the RRC-inactive state. For example, the network sends suitable signaling, message, or notification that indicates to the UE that the UE is to be released to the RRC-inactive state. At 830, the UE transitions from the RRC-connected state to the RRC-inactive state.

At 835, the UE monitors the broadcast signaling for updates to the PTM configuration. At 840, the network sends updated PTM configuration via the broadcast signaling. At 845, the UE receives the updated PTM configuration via the broadcast signaling. At 850, the network sends at least one MBS using the updated PTM configuration. At 855, the UE receives the at least one MBS using the updated PTM configuration.

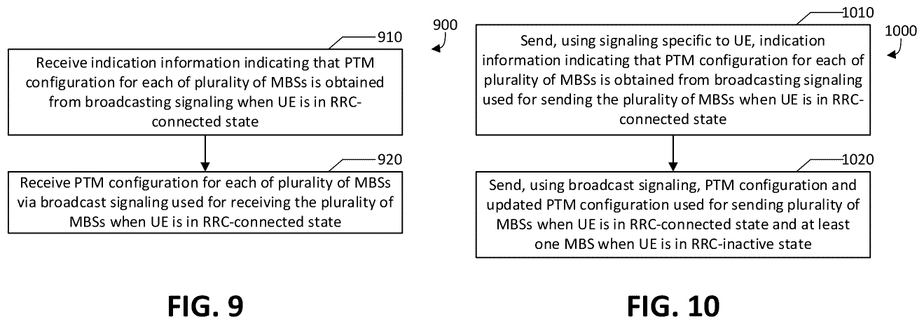

FIG. 9 is a flowchart diagram illustrating an example method 900 for managing MBS, according to various arrangements. Referring to FIGS. 1-9, the method 900 can be performed by one of UE 104a or 104b. The method 800 is a particular implementation of the method 900.

At 910, the UE receives the indication information indicating that PTM configuration for each of the plurality of MBSs is obtained from broadcast signaling when the UE is in the RRC-connected state. At 920, the UE receives the PTM configuration for each of the plurality of MBSs using broadcast signaling used for receiving the plurality of MBSs when the UE is in the RRC-connected state. The PTM configuration is used for receiving the plurality of MBSs when the UE is in the RRC-connected state.

In some arrangements, the method 900 further includes receiving, by the UE from the network, the plurality of MBSs based on the PTM configuration when the UE is in the RRC-connected state. The UE transitions from the RRC-connected state to an RRC-inactive state. The UE monitors when the UE is in the RRC-inactive state, the broadcast signaling for the PTM configuration. The UE receives from the network, PTM configuration using the broadcast signaling. The PTM configuration is used for receiving at least one MBS when the UE is in the RRC-inactive state. The UE receives from the network the at least one MBS based on the PTM configuration.

FIG. 10 is a flowchart diagram illustrating an example method 1000 for managing MBS, according to various arrangements. Referring to FIGS. 1-10, the method 1000 can be performed by the network (e.g., the BS 102). The method 800 is a particular implementation of the method 1000.

At 1010, the network (e.g., the BS 102) sends, to the UE using signaling specific to the UE, indication information indicating that PTM configuration for each of a plurality of MBSs is obtained from broadcast signaling used for sending the plurality of MBSs when the UE is in an RRC-connected state and at least one MBS when the UE is in the RRC-inactive state.

At 1020, the network sends, to the UE using the broadcast signaling, the PTM configuration used for sending the plurality of MBSs when the UE is in the RRC-connected state and the PTM configuration used for sending the at least one MBS when the UE is in an RRC-inactive state.

In some arrangements, the method 1000 further includes sending, by the network to the UE, the plurality of MBSs based on the PTM configuration when the UE is in the RRC-connected state. The network releases the UE from the RRC-connected state to the RRC-inactive state. The network sends to the UE the at least one MBS based on the PTM configuration when the UE is in the RRC-inactive state.

In some examples, there are multicast services with high QoS requirement and low QoS requirement. PTM configuration of multicast by broadcast signaling (e.g., MCCH) lacks the flexibility of UE-level configuration, which may not be able to provide high QoS requirement. For high-QoS multicast services, dedicated signaling can be used to transmit the PTM configuration to ensure reliability. For low-QoS requirement multicast services, the UE can obtain the PTM configuration by monitoring the MCCH signaling based on the instructions of the gNB for scalability, even if the UE is in RRC-connected state.

In some arrangements, a method can be used to indicate the method of distributing the PTM configuration to UE by broadcast signaling, using MCCH which carries the PTM configuration for one UE that needs to receive the MBS and other assistant information, e.g., service availability of one MBS service in neighboring cells. MCCH also uses a modification period, where MCCH contents are only allowed to be modified at each modification period boundary. A notification mechanism is used to announce the change of MCCH contents due to broadcast session start, modification or stop and due to neighboring cell information modification.

When the UE is in the RRC-connected state, the UE obtains the PTM configuration by receiving MCCH, which can be used when the UE is in the RRC-inactive state. In this case, it would be beneficial to assist UE to obtain the broadcast (e.g., MCCH) information using some dedicated signaling, to reduce the power consumption and overall signaling overhead. The assistance information or indication information by dedicated signaling (e.g., signaling specific to the UE) includes (1) information indicating that the PTM configuration is by broadcast signaling (e.g., MCCH); (2) the associated System Information Block (SIB) needed to receive the broadcast signaling (e.g., MCCH); and (3) relevant broadcast (e.g., MCCH) information, including the information needed to receive the PTM configuration.

Accordingly, the indication information is received using signaling specific to the UE (e.g., dedicated signaling). The indication information indicates that the UE is to obtain the PTM information from the broadcast signaling. The indication information includes at least one of information indicating, that PTM configuration of the at least one MBS is provided by broadcasting signaling, SIB used to receive the configuration of broadcasting signaling, broadcast signaling information which contains the PTM configuration of the plurality of MBSs and/or the at least one MBS.

In some arrangements, the dedicated signaling (e.g., RRC reconfiguration) carries the indication information, which indicates that the UE obtains the multicast PTM configuration or the update of the multicast PTM configuration by monitoring the MCCH in the RRC-connected state. In other words, the indication information includes an indication indicating that at least one of the PTM configuration or the updates to the PTM configuration is received via the broadcast signaling. After receiving the indication information, the UE start an MCCH-process to receive the multicast data, e.g., receiving the SIB to obtain the configuration information of MCCH, and then obtaining the relevant multicast PTM configuration information by monitoring the MCCH. The method further includes monitoring, by the UE, a SIB message containing configuration for receiving the broadcast signaling. The UE receives from the network the broadcast signaling containing the PTM configuration or updates to the PTM configuration. The UE receives from the network data corresponding to the at least one MBS based on the updated PTM configuration.

In some arrangements, the dedicated signaling (e.g., RRC reconfiguration) carries the associated system information block message, which includes the information needed to receive the MCCH. The UE performs MCCH monitoring according to this information. In some examples, the SIB message explicitly indicates that for such MBS, the UE obtains the PTM configuration by monitoring MCCH instead of dedicated signaling. Without such indication, the UE assumes the PTM configuration is delivered by legacy configuration method, e.g., by dedicated signaling. Accordingly, the indication information includes a SIB message. The SIB message contains configuration for receiving the broadcast signaling. The indication information indicates that the PTM configuration or the updates to the PTM configuration is obtained from the broadcast signaling. The SIB message is used to obtain the configuration for receiving the broadcast signaling. Data corresponding to the MBS is received based on the PTM configuration. This mechanism reduces the delay of acquiring the associated SIB.

In some arrangements, the dedicated signaling (e.g., RRC reconfiguration) carries MCCH content for the UE interested MBS or the entire MCCH content, which indicates that for such MBS, the corresponding PTM configuration is delivered by the MCCH-like method. The UE then applies the multicast PTM configuration in the MCCH content and performs the multicast data reception according to this information after receiving the MCCH content. The UE can obtain the MCCH by monitoring the MCCH and MCCH change notification by itself following the MCCH monitoring process, or by another dedicated signaling that contains the MCCH content. The indication information includes broadcast signaling information which contains the PTM configuration for the at least one MBS. In some arrangements, the broadcast signaling information that contains the PTM configuration for the at least one MBS is received. Data corresponding to the at least one MBS is received based on the PTM configuration. This mechanism reduces the delay caused by monitoring MCCH.

In some arrangements, when the UE is in the RRC-connected state, the UE regularly monitors the MCCH within a modification period to obtain the multicast PTM configuration. Compared with the dedicated signaling configuration, the scalability is improved, and the air interface overhead caused by the configuration update is reduced if there is a large number of UEs in the cell consuming the same MBS. However, continuously monitoring the MCCH also introduces additional power consumption, especially in current MCCH modification notification mechanism in which the UE has to monitor the MCCH change notification every modification period. Even if the modification is to other MBS (broadcast service, and multicast service if for RRC-inactive UE the MCCH is used for multicast service too) in the cell. Therefore, it is highly possible that UE monitors MCCH, but its interested PTM configuration is not updated.

In some examples, in order to reduce power consumption and to notify the UE the PTM update of multicast service, the network sends to the UE a Short Message with the group paging. In response to receiving a Short Message indicating the PTM update of an MBS, the UE applies the MCCH acquisition procedure in the next modification. If a Short Message is not received, the UE does not perform the MCCH acquisition procedure. Thus, in some arrangements, the UE receives from the network a Short Message indicating the updates to the PTM configuration. In response to receiving the Short Message, the UE performs the acquisition procedure (e.g., the MCCH acquisition procedure) to acquire the broadcast signaling for receiving the updates to the PTM configuration.

In some examples, in order to reduce the power consumption in monitoring the MCCH and the change of multicast service, in the Downlink Control Information (DCI), the network sends an indication to indicate that whether there are PTM configuration update or modification to MBS. For a UE that is interested in multicast service only, if there is no such indication, UE can neglect the MCCH reception in the modification period. Thus, in some arrangements, the UE receives from the network a DCI broadcasting signaling indicating the updates to the PTM configuration. In response to receiving the DCI, the UE performs an acquisition procedure to acquire the broadcast signaling for receiving the updates to the PTM configuration.

In some examples, when the UE is in the RRC-connected state, the network is able to notify UE by dedicated signaling (e.g., RRC signaling, MAC CE), to indicate that the PTM configuration of the multicast services UE is interested in, is about to be updated. In the current or next modification period, the UE monitors the MCCH transmission to receive the latest PTM configuration of its interested multicast services. Thus, in some arrangements, the UE receives from the network a MAC CE indicating the updates to the PTM configuration. In response to receiving the MAC CE, the UE performs an acquisition procedure to acquire the broadcast signaling for receiving the updates to the PTM configuration.

In some arrangements, the UE receives from the network, update signaling specific to the UE when the UE is in the RRC-connected state indicating the updates to the PTM configuration. The broadcasting signaling is monitored in a current or next modification period for the updates to the PTM configuration in response to receiving the update signaling

In some arrangements, when the UE is in the RRC-inactive state, if the indication information is added for UE in RRC-connected state which indicates the PTM configuration of multicast is obtained from MCCH, the MCCH-like method is performed by the UE in RRC-inactive state. For example, the UE receives from the network indication information indicating that the PTM configuration and the updates to the PTM configuration are received via the broadcast signaling both in the RRC-connected state and in the RRC-inactive state.

In some arrangements, the UE 104a or 104b receives the PTM configuration or updates thereof from the network (e.g., the BS 102 or the cell 101) via dedicated signaling and broadcast signaling (e.g., MCCH). For example, when the UE is in the RRC-inactive state, the UE monitors the broadcast signaling (e.g., MCCH) to receive the PTM configuration or updates thereof for multicast. When the UE is in RRC-connected state, the UE receives PTM configuration from the network through dedicated signaling.

In some arrangements, when the UE is in the RRC-connected state, the PTM configuration of MBS is obtained from dedicated signaling. When the UE is in the RRC-inactive state, the PTM configuration of MBS is obtained from broadcast signaling (e.g., MCCH).

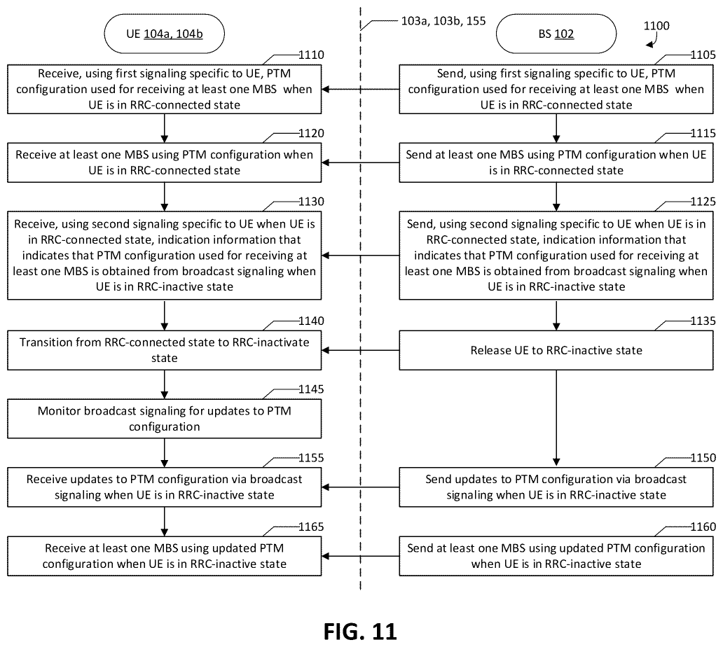

FIG. 11 is a flowchart diagram illustrating an example method 1100 for managing MBS, according to various arrangements. Referring to FIGS. 1-11, the method 1100 can be performed by the network (e.g., the BS 102) and one of UE 104a or 104b. Communications between the UE and the BS are performed over respectively ones of the channels 103a, 103b, or 155, shown as the dashed line in FIG. 11.

At 1105, the network (e.g., the BS 102) sends, to the UE using first signaling specific to the UE (e.g., dedicated signaling) PTM configuration for each of at least one MBS when the UE is in the RRC-connected state. At 1110, the UE receives the PTM configuration for each of the at least one MBS using first signaling specific to the UE when the UE is in the RRC-connected state. Accordingly, for a UE that is in the RRC-connected state, the PTM configuration is delivered to UE by dedicated signaling.

At 1115, the network sends data corresponding to the at least one MBS using the PTM configuration received at 1110 when the UE is in the RRC-connected state. At 1120, the UE receives from the network the data corresponding to the at least one MBS using the PTM configuration when the UE is in the RRC-connected state.

At 1125, the network sends, to the UE using second signaling specific when the UE is in the RRC-connected state, indication information indicating that the PTM configuration used for receiving the at least one MBS is obtained from broadcast signaling when the UE is in the RRC-inactive state. At 1130, the UE receives, from the network using second signaling specific to the UE when the UE is in the RRC-connected state, indication information indicating that the PTM configuration used for receiving the at least one MBS is obtained from broadcast signaling when the UE is in the RRC-inactive state. In some examples, the first signaling and the second signaling are the same signaling. In other examples, the first signaling and the second signaling are different.

At 1135, the network releases the UE to the RRC-inactive state. For example, the network sends suitable signaling, message, or notification that indicates to the UE that the UE is to be released to the RRC-inactive state. At 1140, the UE transitions from the RRC-connected state to the RRC-inactive state.

At 1145, the UE monitors the broadcast signaling for the PTM configuration for any of the at least one MBS or updates to the PTM configuration for any of the at least one MBS. At 1150, the network sends updates to the PTM configuration or PTM configuration via the broadcast signaling when the UE is in the RRC-inactive state. At 1155, the UE receives from the network updates to the PTM configuration or PTM configuration via the broadcast signaling when the UE is in the RRC-inactive state.

At 1160, the network sends the at least one MBS using the updated PTM configuration when the UE is in the RRC-inactive state. At 1165, the UE receives the at least one MBS using the updated PTM configuration when the UE is in the RRC-inactive state.

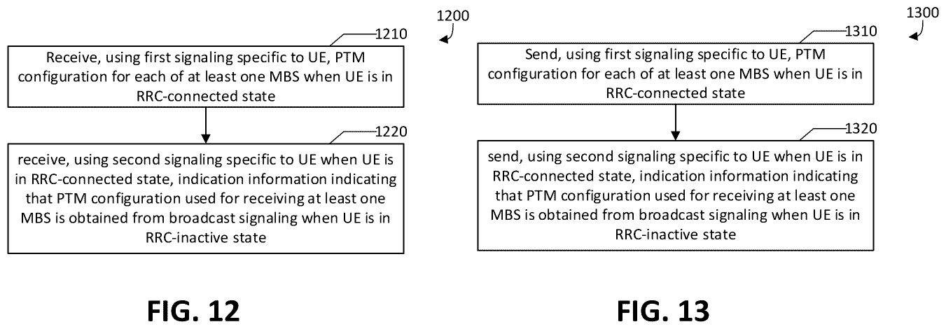

FIG. 12 is a flowchart diagram illustrating an example method 1200 for managing MBS, according to various arrangements. Referring to FIGS. 1-12, the method 1200 can be performed by one of UE 104a or 104b. The method 1100 is a particular implementation of the method 1200.

At 1210, the UE receives the PTM configuration for each of the at least one MBS using first signaling specific to the UE when the UE is in the RRC-connected state. Accordingly, for a UE that is in the RRC-connected state, the PTM configuration is delivered to UE by dedicated signaling.

At 1220, the UE receives, from the network using second signaling specific to the UE when the UE is in the RRC-connected state, indication information indicating that the PTM configuration used for receiving the at least one MBS is obtained from broadcast signaling when the UE is in the RRC-inactive state. In some examples, the first signaling and the second signaling are the same signaling. In other examples, the first signaling and the second signaling are different.

In some arrangements, the method 1200 further includes receiving, by the UE from the network using the broadcast signaling, the PTM configuration used for receiving the at least one MBS when the UE is in the RRC-inactive state, and receiving, by the UE from the network, the PTM configuration from the broadcast signaling when the UE is in the RRC-inactive state.

The indication information includes at least one of information indicating that the PTM configuration of the at least one MBS is provided by the broadcasting signaling, SIB used to receive the broadcasting signaling, and broadcast signaling information containing the PTM configuration of the at least one MBS used in the RRC-inactive state.

FIG. 13 is a flowchart diagram illustrating an example method 1300 for managing MBS, according to various arrangements. Referring to FIGS. 1-13, the method 1300 can be performed by the network (e.g., the BS 102). The method 1100 is a particular implementation of the method 1300.

At 1310, the network (e.g., the BS 102) sends, to the UE using first signaling specific to the UE (e.g., dedicated signaling) PTM configuration for each of at least one MBS when the UE is in the RRC-connected state. Accordingly, for a UE that is in the RRC-connected state, the PTM configuration is delivered to UE by dedicated signaling.

At 1320, the network sends, to the UE using second signaling specific when the UE is in the RRC-connected state, indication information indicating that the PTM configuration used for receiving the at least one MBS is obtained from broadcast signaling when the UE is in the RRC-inactive state. In some examples, the first signaling and the second signaling are the same signaling. In other examples, the first signaling and the second signaling are different.

In some examples, the method 1300 further includes sending, by the network to the UE using the broadcast signaling, the PTM configuration used for receiving the at least one MBS when the UE is in the RRC-inactive state and sending, by the network to the UE, the updates to the PTM configuration when the UE is in the RRC-inactive state.

Accordingly, when the UE in RRC-connected state, the PTM configuration of the MBS is delivered by dedicated signaling. In response to the UE being released to RRC-inactive state by network, to continue the MBS reception, the PTM configuration is reacquired from the broadcasting (e.g., MCCH).

It would be beneficial to assist UE to obtain the MCCH information when the UE in RRC-inactive state, with some dedicated signaling, e.g., RRC reconfiguration, RRC release, and so on. To reduce the power consumption and overall signaling overhead. The indication information by dedicated signaling includes at least one of information indicating that the MBS configuration is by broadcast (e.g., MCCH), the associated SIB needed to receive MCCH, and relevant MCCH information, including the information needed to receive the MBS configuration.

In some examples, the RRC reconfiguration carries the indication information, which indicates that the UE obtains the multicast PTM configuration or the update of the multicast PTM configuration by monitoring the MCCH in the RRC-inactive state. Accordingly, in some examples, the indication information comprises an indication indicating that at least one of the PTM configuration or updates to the PTM configuration of at least one MBS is received via the broadcast signaling. The broadcasting signaling is received and monitored by the UE in response to receiving the indication when the UE is in the RRC-inactive state. The indication information is carried in an RRC reconfiguration message.

In one example, in response to receiving the indication information and in response to the UE being released to the RRC-inactive state by network, to continue the MBS reception, the corresponding PTM configuration, e.g., the associated MRB and the lower layer configuration of the multicast session, is retained temporarily. The UE starts MCCH-like process to receive the MBS data in the RRC-inactive state, e.g., receiving the SIB to obtain the configuration information of MCCH, and then obtain the relevant PTM configuration information by monitoring MCCH. Before acquiring the updated PTM configuration, the UE continues to apply the current PTM configuration for receiving one or more of the at least one MBS, where the current PTM configuration may be received when the UE is in the RRC-connected state. Accordingly, in response to receiving the indication, retaining, by the UE, the PTM configuration corresponding to one MBS of the at least one MBS to continue receiving the one MBS in response to the UE transitioning from the RRC-connected state to the RRC-inactive state. The UE releases the PTM configuration received in RRC-connected state after the UE receives the PTM configuration through broadcast signaling in RRC-inactive state.

In another example, in response to receiving the indication information and in response to the UE being released to RRC-inactive state by network, the UE starts the MCCH-like process to receive the multicast data in the RRC-inactive state, e.g., receiving the SIB to obtain the configuration information of MCCH, and then obtain the relevant multicast PTM configuration information by monitoring MCCH. Therefore, in response to receiving the indication, the UE releases the PTM configuration corresponding to an MBS of the at least one MBS in response to the UE transitioning from the RRC-connected state to the RRC-inactive state, and receives the broadcast signaling for updates to the PTM configuration in response to the UE transitioning from the RRC-connected state to the RRC-inactive state.

In some arrangements, the RRC release carries the indication information, which indicates that the UE obtains the multicast PTM configuration or the update of the multicast PTM configuration by monitoring the MCCH in the RRC-inactive state.

In response to transitioning from the RRC-connected state to the RRC-inactive state, the UE monitors for a SIB message, the SIB message includes configuration for receiving the broadcast signaling when the UE is in the RRC-inactive state. The UE receives from the network the broadcast signaling for obtaining the PTM configuration or updates to the PTM configuration for the at least one MBS when the UE is in the RRC-inactive state. The UE receives the data corresponding to the at least one MBS based on the updated PTM configuration.

In one example, in response to the UE being released to RRC-inactive state by network, to continue the MBS reception, the corresponding PTM configuration, e.g., the associated MRB and the lower layer configuration of the multicast session, is retained temporarily. The UE starts the MCCH-like process to receive the MBS data in the RRC-inactive state, e.g., receiving the SIB to obtain the configuration information of MCCH, and then obtain the relevant multicast PTM configuration information by monitoring MCCH. Therefore, in response to receiving the indication information, the UE retains the PTM configuration corresponding to one MBS of the at least one MBS to continue receiving the one MBS in response to the UE transitioning from the RRC-connected state to the RRC-inactive state. The UE releases the PTM configuration received by the UE in the RRC-connected state after the UE receives a PTM configuration through broadcast signaling in the RRC-inactive state. Before acquiring the updated PTM configuration, the UE continues to apply the current PTM configuration for receiving one or more of the at least one MBS, where the current PTM configuration may be received when the UE is in the RRC-connected state.

In another example, in response to the UE being released to RRC-inactive state by network, the UE starts the MCCH-like process to receive the MBS data in the RRC-inactive state, e.g., receiving the SIB to obtain the configuration information of MCCH, and then obtain the relevant multicast PTM configuration information by monitoring MCCH. In other words, in response to receiving the indication information, the UE releases the PTM configuration corresponding to one MBS of the at least one MBS in response to the wireless communication device transitioning from the RRC-connected state to the RRC-inactive state. The UE receives the broadcast signaling for updates to the PTM configuration in response to the UE transitioning from the RRC-connected state to the RRC-inactive state.

In some arrangements, the RRC release carries the associated SIB message, which includes the information needed to receive the MCCH. UE released to RRC-inactive state, UE performs MCCH monitoring according to this information. The SIB of the indication information is carried in a RRC release message. This mechanism reduces the delay of acquiring the associated SIB.

In some arrangements, in response to transitioning from the RRC-connected state to the RRC-inactive state, the UE receives from the network based on the SIB the broadcast signaling, to obtain the PTM configuration or updates to the PTM configuration for the at least one MBS when the UE is in the RRC-inactive state. The UE receives from the network data corresponding to the at least one MBS based on the updates to the PTM configuration.

In some examples, the SIB explicitly indicates that for selected MBS, to continue the MBS reception, the corresponding PTM configuration, e.g., the associated MRB and the lower layer configuration of the MBS session, is retained temporarily in response to the UE being released to RRC-inactive state. The UE starts the MCCH-like process to receive the MBS data in the RRC-inactive state, e.g., to obtain the relevant multicast PTM configuration information by monitoring MCCH. Thus, in response to receiving the SIB, the UE retains the PTM configuration corresponding to one MBS of the at least one MBS to continue receiving the one MBS in response to the UE transitioning from the RRC-connected state to the RRC-inactive state. The UE releases the PTM configuration received by the UE in RRC-connected state after the UE receives the PTM configuration through broadcast signaling in RRC-inactive state.

Without receiving such indication information, the UE initiates the traditional RRC connection release process and transitions to the RRC-inactive state. Before acquiring the updated PTM configuration, the UE continues to apply the current PTM configuration for receiving one or more of the at least one MBS, where the current PTM configuration may be received when the UE is in the RRC-connected state.

In some examples, the SIB explicitly indicates that for selected MBS, in response to the UE being released to RRC-inactive state, the UE starts the MCCH-like process to receive the MBS data in the RRC-inactive state, e.g., to obtain the relevant PTM configuration information by monitoring MCCH. Thus, in response to receiving the SIB, the UE release the PTM configuration corresponding to one MBS of the at least one MBS in response to the UE transitioning from the RRC-connected state to the RRC-inactive state, and the UE receives from the network the broadcast signaling for updates to the PTM configuration in response to the UE transitioning from the RRC-connected state to the RRC-inactive state. Without receiving such indication information, the UE initiates the traditional RRC connection release process and transitions to the RRC-inactive state.

In some arrangements, the RRC release carries MCCH content for the UE interested MBS or the entire MCCH content, which indicates that for such MBS, the corresponding PTM configuration is delivered by MCCH-like method in the RRC-inactive state. This mechanism reduces the delay caused by monitoring MCCH. The indication information includes broadcast signaling information which contains the PTM configuration of the at least one MBS used when the UE is in the RRC-inactive state.

In one example, to continue the MBS reception, the UE retains the corresponding PTM configuration, e.g., the associated MRB and the lower layer configuration of the multicast session, temporarily in response to the UE being released to RRC-inactive state. The UE applies the PTM configuration in the MCCH content and performs the MBS data reception according to this configuration. Then, UE obtains the MCCH by monitoring the MCCH and MCCH change notification by itself following the MCCH monitoring process in legacy. Before acquiring the updated PTM configuration, the UE continues to apply the current PTM configuration for receiving one or more of the at least one MBS, where the current PTM configuration may be received when the UE is in the RRC-connected state.

In another example, in response to the UE being released to RRC-inactive state, UE applies the PTM configuration in the MCCH content and performs the multicast data reception according to this configuration. Then, UE obtains the MCCH by monitoring the MCCH and MCCH change notification by itself following the MCCH monitoring process in legacy.

In some examples, in response to transitioning from the RRC-connected state to the RRC-inactive state, the UE receives from the network data corresponding to the at least one MBS based on PTM configuration in the indication information. In response to receiving the indication information, the UE retains the PTM configuration corresponding to one MBS of the at least one MBS to continue receiving the one MBS in response to the UE transitioning from the RRC-connected state to the RRC-inactive state. In response to receiving the indication information, the UE monitors updates to the PTM configuration in response to the wireless communication device transitioning from the RRC-connected state to the RRC-inactive state.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It is understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is further understood by those within the art that if a specific number of an introduced claim recitation is intended, such an intent is explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to the disclosure containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It is further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” is understood to include the possibilities of “A” or “B” or “A and B.”

Further, unless otherwise noted, the use of the words “approximate,” “about,” “around,” “substantially,” etc., mean plus or minus ten percent.

The foregoing description of illustrative implementations has been presented for purposes of illustration and of description. It is not intended to be exhaustive or limiting with respect to the precise form disclosed, and modifications and variations are possible in light of the above teachings or may be acquired from practice of the disclosed implementations. It is intended that the scope of the disclosure be defined by the claims appended hereto and their equivalents.

What is claimed is:

1. A wireless communication method, comprising:
receiving, by a wireless communication device from a network using a signaling specific to the wireless communication device when the wireless communication device is in a Radio Resource Control (RRC)-connected state, indication information,
wherein the indication information indicates that Point-to-Multipoint (PTM) configuration used for receiving at least one Multicast and Broadcast Service (MBS) is to be obtained from broadcast signaling when the wireless communication device is in an RRC-inactive state.

2. The wireless communication method of claim 1, further comprising:
receiving, by the wireless communication device from the network using the broadcast signaling, the PTM configuration used for receiving the at least one MBS when the wireless communication device is in the RRC-inactive state; and
receiving, by the wireless communication device from the network, updates to the PTM configuration when the wireless communication device is in the RRC-inactive state.

3. The wireless communication method of claim 1, wherein
the indication information comprises an indication indicating that the PTM configuration or updates to the PTM configuration of at least one MBS is received via the broadcast signaling; and
the broadcasting signaling is received by the wireless communication device in response to receiving the indication when the wireless communication device is in the RRC-inactive state.

4. The wireless communication method of claim 3, further comprising:
in response to receiving the indication, retaining, by the wireless communication device, the PTM configuration corresponding to one MBS of the at least one MBS to continue receiving the one MBS in response to the wireless communication device transitioning from the RRC-connected state to the RRC-inactive state; and
releasing, by the wireless communication device, the PTM configuration received by the wireless communication device in RRC-connected state after the wireless communication device receives the PTM configuration through broadcast signaling in RRC-inactive state.

5. The wireless communication method of claim 3, further comprising:
in response to receiving the indication, releasing, by the wireless communication device, the PTM configuration corresponding to one MBS of the at least one MBS in response to the wireless communication device transitioning from the RRC-connected state to the RRC-inactive state; and
receiving the broadcast signaling for updates to the PTM configuration in response to the wireless communication device transitioning from the RRC-connected state to the RRC-inactive state.

6. The wireless communication method of claim 1, further comprising:
in response to transitioning from the RRC-connected state to the RRC-inactive state, monitoring, by the wireless communication device, for a System Information Block (SIB) message, wherein the SIB message includes configuration for receiving the broadcast signaling when the wireless communication device is in the RRC-inactive state;
receiving, by the wireless communication device from the network, the broadcast signaling for obtaining the PTM configuration or updates to the PTM configuration for the at least one MBS when the wireless communication device is in the RRC-inactive state; and
receiving data corresponding to the at least one MBS based on the PTM configuration.

7. The wireless communication method of claim 3, wherein the indication information is carried in a Radio Resource Control (RRC) release message.

8. The wireless communication method of claim 7, further comprising:
in response to receiving the indication information, retaining, by the wireless communication device, the PTM configuration corresponding to one MBS of the at least one MBS to continue receiving the one MBS in response to the wireless communication device transitioning from the RRC-connected state to the RRC-inactive state; and
releasing, by the wireless communication device, the PTM configuration received by the wireless communication device in RRC-connected state after the wireless communication device receives the PTM configuration through broadcast signaling in the RRC-inactive state.

9. The wireless communication method of claim 7, further comprising:
in response to receiving the indication information, releasing, by the wireless communication device, the PTM configuration corresponding to one MBS of the at least one MBS in response to the wireless communication device transitioning from the RRC-connected state to the RRC-inactive state; and
receiving, by the wireless communication device, the broadcast signaling for updates to the PTM configuration in response to the wireless communication device transitioning from the RRC-connected state to the RRC-inactive state.

10. The wireless communication method of claim 1, wherein a System Information Block (SIB) in the indication information is carried in a Radio Resource Control (RRC) release message.

11. The wireless communication method of claim 10, further comprising:
in response to transitioning from the RRC-connected state to the RRC-inactive state, receiving, by the wireless communication device from the network based on the SIB, the broadcast signaling, to obtain the PTM configuration or updates to the PTM configuration for the at least one MBS when the wireless communication device is in the RRC-inactive state; and
receiving, by the wireless communication device from the network, data corresponding to the at least one MBS based on the updates to the PTM configuration.

12. The wireless communication method of claim 10, further comprising:
in response to receiving the SIB, retaining, by the wireless communication device, the PTM configuration corresponding to one MBS of the at least one MBS to continue receiving the one MBS in response to the wireless communication device transitioning from the RRC-connected state to the RRC-inactive state; and
releasing, by the wireless communication device, the PTM configuration received by the wireless communication device in RRC-connected state after the wireless communication device receives the PTM configuration through broadcast signaling in the RRC-inactive state.

13. The wireless communication method of claim 10, further comprising:
in response to receiving the SIB, releasing, by the wireless communication device, the PTM configuration corresponding to one MBS of the at least one MBS in response to the wireless communication device transitioning from the RRC-connected state to the RRC-inactive state; and
receiving, by the wireless communication device by the wireless communication device from the network, the broadcast signaling for updates to the PTM configuration in response to the wireless communication device transitioning from the RRC-connected state to the RRC-inactive state.

14. The wireless communication method of claim 1, wherein the indication information comprises broadcast signaling information which includes the PTM configuration of the at least one MBS used when the wireless communication device is in the RRC-inactive state.

15. The wireless communication method of claim 14, further comprising in response to transitioning from the RRC-connected state to the RRC-inactive state, receiving, by the wireless communication device from the network, data corresponding to the at least one MBS based on the PTM configuration in the indication information.

16. The wireless communication method of claim 14, further comprising in response to receiving the indication information, monitoring, by the wireless communication device, updates to the PTM configuration in response to the wireless communication device transitioning from the RRC-connected state to the RRC-inactive state.

17. A wireless communication device, comprising:
at least one processor configured to:
receive, via a receiver from the network using a signaling specific to a wireless communication device when the wireless communication device is in a Radio Resource Control (RRC)-connected state, indication information,
wherein the indication information indicates that Point-to-Multipoint (PTM) configuration used for receiving at least one Multicast and Broadcast Service (MBS) is to be obtained from broadcast signaling when the wireless communication device is in an RRC-inactive state.

18. A wireless communication method, comprising:
sending, by a network to a wireless communication device using a signaling specific to the wireless communication device when the wireless communication device is in a Radio Resource Control (RRC)-connected state, indication information,
wherein the indication information indicates that Point-to-Multipoint (PTM) configuration used for receiving at least one Multicast and Broadcast Service (MBS) is to be obtained from broadcast signaling when the wireless communication device is in an RRC-inactive state.

19. A network node, comprising:
at least one processor configured to:
send, via a transmitter to a wireless communication device using a signaling specific to the wireless communication device when the wireless communication device is in a Radio Resource Control (RRC)-connected state, indication information,
wherein the indication information indicates that Point-to-Multipoint (PTM) configuration used for receiving at least one Multicast and Broadcast Service (MBS) is to be obtained from broadcast signaling when the wireless communication device is in an RRC-inactive state.
